(19) United States
(12) Patent Application Publication
(10) Pub. No.: US 2007/0081502 A1
(43) Pub. Date: Apr. 12, 2007

(54) Apparatus and method for constructing a frame to support multilink in multi-hop relay cellular network

(75) Inventors: Mi-Hyun Lee, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Hyun-Jeong Kang, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/542,848

(22) Filed: Oct. 4, 2006

(30) Foreign Application Priority Data
Oct. 6, 2005 (KR) 10-2005-0093832

(51) Int. Cl. H04B 7/212

(52) U.S. Cl. 370/337; 370/470; 370/474

(57) ABSTRACT

Provided is an apparatus and method for constructing a subframe to support a multi link in a multi-hop relay cellular network. In a first section of a subframe, a subframe for communication with a mobile station (MS) is constructed, and in a next second section of the subframe, a subframe for communication with a relay station (RS) is constructed. Therefore, resources can be efficiently used without interference between subframes, pilots can be flexibly used, advanced technologies can be easily applied, and overhead due to RS switching gaps can be reduced.

### PRIORITY

This application claims priority under 35 U.S.C. § 119 to a Korean application filed in the Korean Intellectual Property Office on Oct. 6, 2005 and allocated Serial No. 2005-93832, the contents of which are incorporated herein by reference.

### BACKGROUND OF THE INVENTION

1. Field of the Invention

The present invention relates generally to a multi-hop relay cellular network, and more particularly, to an apparatus and method for constructing a frame to support a multi link in a multi-hop relay cellular network without interference in a cell.

2. Description of the Related Art

Nowadays, many people carry a variety of digital electronic devices such as notebook computers, portable phones, PDAs, and MP3 players. In most cases, the portable digital electronic devices operate independently without interaction with one another. If the portable digital electronic devices themselves can configure a wireless network without the aid of a central control system, they can easily share various data with one another, which makes it possible to provide a variety of novel data communication services. Such a wireless network capable of providing communications between devices whenever and wherever without the aid of a central control system is called an “ad-hoc network” or a “ubiquitous network”.

Research is being actively conducted on the fourth-generation (4G) mobile communication system, and a self-configurable wireless network is one of the most important requirements for the 4G mobile communication system.

The self-configurable wireless network makes it possible to provide a mobile communication service by configuring a wireless network independently or in a distributed fashion without the aid of a central control system. In the 4G mobile communication system, a plurality of cells with a very small radius are installed to provide high-rate data communication and accommodate a large amount of traffic. In the 4G mobile communication system, it is impossible to implement a centralized network using the existing wireless network design as it is. A 4G wireless network must be able to actively provide for an environment change such as addition of new base stations (BSs) while being constructed and controlled in a distributed fashion. For this reason, the 4G mobile communication system requires constructing the self-configurable wireless network.

Technologies for the ad-hoc network are introduced in a mobile communication system to implement the self-configurable wireless network for the 4G mobile communication system. A typical example of this is a multi-hop relay cellular network in which a multi-hop relay scheme for the ad-hoc network is introduced in a cellular network configured with a stationary BS.

In the cellular network, it is possible to easily establish a high-reliability wireless communication link between a BS and a mobile station (MS) because communication between the BS and the MS is performed through one direct link.

However, because the BS is stationary, the cellular network is low in flexibility in construction of a wireless network, which makes it difficult to provide an efficient service in an environment with a great change in traffic distribution or requirements.

In order to overcome this difficulty, a relay scheme is used that transmits data in a multi-hop fashion through neighboring MSs or relay stations (RSs). The multi-hop relay scheme makes it possible to rapidly reconstruct a network suitable for peripheral environments and to efficiently operate the entire wireless network. Furthermore, since a multi-hop relay path can be established by locating an RS between a BS and an MS, an improved wireless channel can be provided to the MS. Moreover, the multi-hop relay path can be used to provide a high-rate data channel to MSs located in a shadow area where the MSs cannot communicate directly with a BS, thereby making it possible to expand a cell coverage area.

FIG. 1 illustrates a typical multi-hop relay cellular network.

Referring to FIG. 1, an MS 110, which is located inside a coverage area 101 of a BS 100, communicates directly with the BS 100. On the contrary, an MS 120, which is located outside the coverage area 101 and thus has poor channel conditions, communicates indirectly with the BS 100 through an RS 130.

There is a case where the MSs 110 and 120 communicate directly with the BS 100 but has poor channel conditions because they are located at the edge of the BS coverage area 101. In this case, the RS 130 can be used to provide a better radio channel. Therefore, using a multi-hop relay scheme, the BS 100 can provide a high-rate data channel in a cell boundary region with a poor channel condition and thus can expand a cell service area (i.e., the coverage area 101).

Air interface resources should be dynamically distributed between a BS and an RS so as to allow an MS to communicate with the BS or the RS depending on the location of the MS in a multi-hop relay cellular network. Furthermore, frame-by-frame relaying and frame-in-frame relaying are also considered to support the dynamic distribution.

In a frame-by-frame relaying scheme, a BS transmits and receives in one frame, and an RS transmits and receives in the next frame. In a frame-in-frame relaying scheme, one frame is divided into subframes based on orthogonal resources so as to allow a BS and an RS to transmit and receive in one frame. Therefore, the frame-in-frame relaying structure may have a short delay and a short round trip time since the subframes are transmitted through a multi link. Here, the orthogonal resources may be time, frequency, space, codes, or combinations thereof.

In a multi-hop relay cellular network, a link between an RS and an MS should be established in the same way as a link between a BS and the MS so as to allow the MS to communicate with the RS without additional hardware overhead. Furthermore, a highly reliable link should be established between the BS and the RS without interference with the existing link between the BS and the MS.

For example, in a subframe-in-subframe format designed to transmit a BS-RS subframe and an RS-MS subframe in one subframe, an RS should transmit and receive in one subframe, thereby making it difficult to isolate radio frequency and increasing complexity of hardware.

In addition, when different bursts are allocated to a BS/MS subframe and an RS/MS subframe that are included in one subframe so as to distinguish the BS/MS subframe and the RS/MS subframe, bursts can be transmitted between a BS and a plurality of RSs. Here, bursts should be allocated in the same permutation to distinguish multi links in a cell, and thereby to remove interference between bursts. However, in this case, pilot subcarriers can be overlapped with each other although data subcarriers of the bursts are not overlapped with each other. When different transmitting ends use the same pilot subcarrier, a receiving end finds it difficult to exactly estimate a channel allocated to its bursts. Therefore, a permutation having a dedicated pilot is used to prevent pilot carrier collision between bursts.

### SUMMARY OF THE INVENTION

An object of the present invention is to substantially solve at least the above problems and/or disadvantages and to provide at least the advantages below. Accordingly, an object of the present invention is to provide a method for constructing a frame that reduces interference and increases flexibility in use of a pilot in a multi-hop relay cellular network, and an apparatus for supporting the method.

Another object of the present invention is to provide an apparatus and method for improving flexibility in use of a pilot and removing interference in a cell in a multi-hop relay cellular network by constructing a BS-RS subframe and an RS-MS subframe that have different time slots.

According to one aspect of the present invention, there is provided a method for constructing a subframe to support a multi link in a multi-hop relay cellular network, the method including constructing a first section of the subframe, the first section including a BS (Base station)-MS (Mobile Station) subframe for a link between a BS and an MS and an RS (Relay Station)-MS subframe for a link between an RS and the MS; and constructing a second section of the subframe, the second section including a BS-RS subframe for a link between the BS and the RS.

According to another aspect of the present invention, there is provided a method for constructing a subframe to support a multi link in a multi-hop relay cellular network, the method including constructing a first section of the subframe, the first section including a BS-RS subframe for a link between a BS and an RS and an BS-MS subframe for a link between the BS and an MS; and constructing a second section of the subframe, the second section including an RS-MS subframe for a link between the RS and the MS and a BS-MS subframe for a link between the BS and the MS.

According to a further another aspect of the present invention, there is provided a method for constructing a subframe to support a multi link in a multi-hop relay cellular network, the method including constructing a BS-RS subframe for a link between a BS and an RS in a first section of the subframe; constructing a BS-MS subframe for a link between the BS and an MS in a second section of the subframe; and constructing an RS-MS subframe for a link between the RS and the MS in a third section of the subframe.

According to a still further another aspect of the present invention, there is provided a method for constructing a subframe to support a multi link in a multi-hop relay cellular network, the method including constructing a subframe for a direct link in a first section of the subframe; and constructing a subframe for a relay link in a second section of the subframe.

According to a yet further another aspect of the present invention, there is provided an apparatus for constructing a frame to support a multi link in a multi-hop relay cellular network, the apparatus including a timing controller for generating a timing signal to provide information about a subframe transmission time according to a predetermined framing scheme; a frame constructor for constructing a frame with subframes using the timing signal; and a resource scheduler for mapping the subframes using resources allocated to bursts of each link.

According to an even further another aspect of the present invention, there is provided a method for constructing a subframe to support a multi link in a multi-hop relay cellular network. In the method, a subframe for each link is divided into one or more sections. A first section of the subframe includes at least one subframe, a second section of the subframe placed after the first section by a frame-by-frame scheme and includes at least one subframe, and a third section of the subframe placed after the second section by the frame-by-frame scheme and includes at least one subframe, to construct a superframe.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a typical multi-hop relay cellular network;

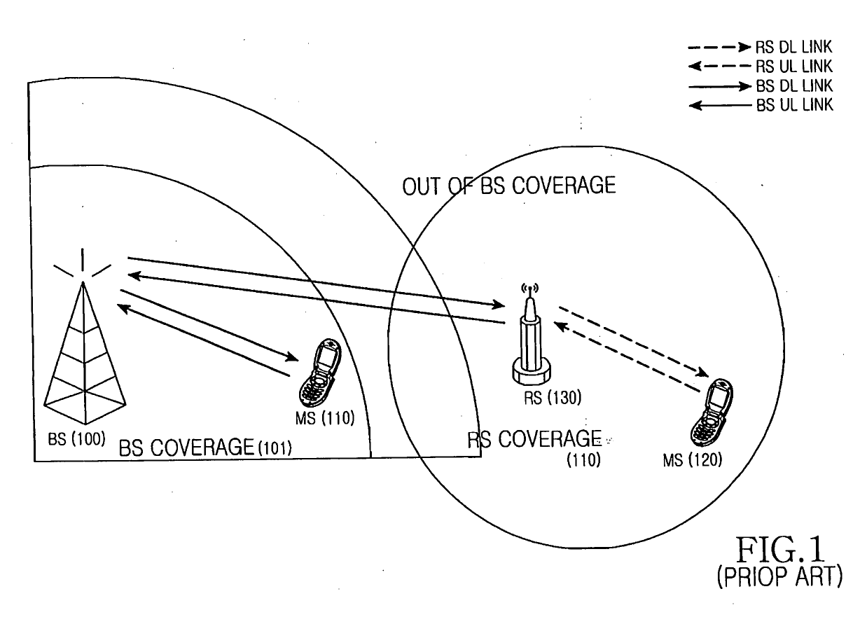

FIG. 2 illustrates a subframe structure for a multi-hop relay cellular network according to a first embodiment of the present invention;

FIG. 3 illustrates a subframe structure for a multi-hop relay cellular network according to a second embodiment of the present invention;

FIG. 4 illustrates a subframe structure for a multi-hop relay cellular network according to a third embodiment of the present invention;

FIG. 5 illustrates a subframe structure for a multi-hop relay cellular network according to a fourth embodiment of the present invention;

FIG. 6 illustrates a frame structure for a multi-hop relay cellular network according to a first embodiment of the present invention;

FIG. 7 illustrates a frame structure for a multi-hop relay cellular network according to a second embodiment of the present invention;

FIG. 8 illustrates a frame structure for a multi-hop relay cellular network according to a third embodiment of the present invention;

FIG. 9 illustrates a frame structure for a multi-hop relay cellular network according to a fourth embodiment of the present invention;

FIG. 10 illustrates a frame structure for a multi-hop relay cellular network according to a fifth embodiment of the present invention;

FIG. 11 illustrates a frame structure for a multi-hop relay cellular network according to a sixth embodiment of the present invention;

FIG. 12 illustrates a frame structure for a multi-hop relay cellular network according to a seventh embodiment of the present invention; and

FIG. 13 illustrates an apparatus for constructing a frame in a multi-hop relay cellular network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method for constructing a subframe for effectively distributing air interface resources without interference in a multi-hop relay cellular network and an apparatus for supporting the method will be described in detail. Herein, a time division duplex (TDD) wireless communication system and an orthogonal frequency division multiple access (OFDMA) wireless communication system are taken as examples to explain the present invention. However, the present invention can be applied to other wireless communication systems.

Further, in the following description, a subframe for communication between a BS and an RS will be referred to as a BS-RS subframe, a subframe for communication between a BS and an MS as a BS-MS subframe, and a subframe for communication between an RS and an MS as an RS-MS subframe. Furthermore, the horizontal axis of the subframe denotes time, and the vertical axis of the subframe denotes frequency. When allocated regions of the subframe can be dynamically changed according to the situation, a dashed line is used between the allocation regions. In addition, resources are allocated to bursts in the subframe for each link using a two-dimensional scheme (time and frequency).

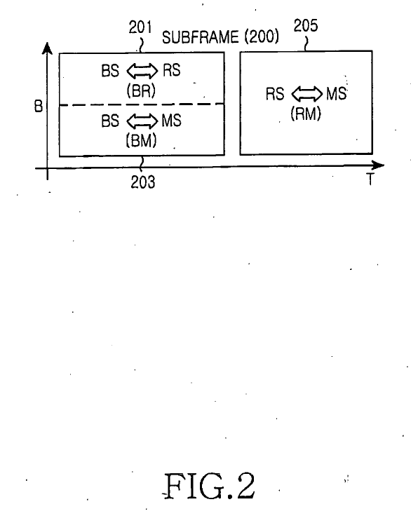

FIG. 2 illustrates a subframe structure for a multi-hop relay cellular network according to a first embodiment of the present invention.

Referring to FIG. 2, a subframe 200 includes a first section for communication with a BS by a direct link and a second section for communication with the BS by a relay link. The first and second sections are separated by a time slot such that each of the BS, an RS, and an MS can be controlled to receive a signal only in its time section. The first and second sections can be arranged in a reversed order.

The first section for direct communication with the BS is divided into a BS-RS subframe 201 and a BS-MS subframe 203. The BS-RS subframe 201 and the BS-MS subframe 203 are separately located in the single section (the first section) of the subframe 200 by a subframe-in-subframe scheme and have different bursts. That is, the BS generates the subframe 200 by regarding the RS as an MS.

Here, the subframes 201 and 203 can be assigned for the bursts using a subcarrier or a set of subcarriers. In this case, since resource granularity decreases, resources can be efficiently used compared with the case where bursts are assigned different time slots in units of a symbol.

In the first section made up of the BS-RS subframe 201 and the BS-MS subframe 203, the BS transmits the same subframe. Therefore, the BS can broadcast control information commonly in the subframes 201 and 203. That is, the BS does not need to repeatedly transmit the broadcasting information to the subframes of different links.

Meanwhile, the second section of the subframe 200 includes an RS-MS subframe 205 for a relay link. Here, the second section is located beside the first section in the subframe 200 by a subframe-by-subframe scheme.

Since a plurality of RSs transmit different bursts using the RS-MS subframe 205, each burst is assigned a permutation having a dedicated pilot. Further, since bursts in the RS-MS subframe 205 can be assigned resources on a time priority basis, a high Signal to Interference and Noise Ratio (SINR) can be obtained at a receiving end. That is, narrowband operation gain can be obtained. Here, the narrowband operation gain means that a high SINR can be obtained at a receiving end in frequency domain when a transmission power is maintained at a constant level in time domain to occupy a narrowband although an occupied bandwidth varies in frequency domain.

Further, in the subframe-in-subframe scheme, a subframe is divided by burst allocation based on orthogonal resources, and in the subframe-by-subframe scheme, a subframe is divided by assigning different time slots.

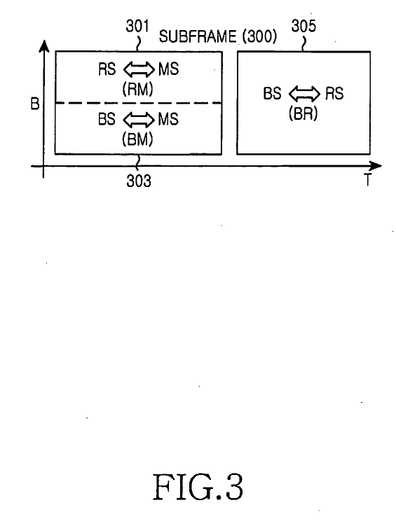

FIG. 3 illustrates a subframe structure for a multi-hop relay cellular network according to a second embodiment of the present invention.

Referring to FIG. 3, a subframe 300 includes a first section for communication with an MS and a second section for communication between a BS and an RS. The first and second sections are separated by a time resource. Further, the first and second sections are separated by a subframe-by-subframe scheme and can be arranged in a reversed order.

The first section for communication with the MS is divided into an RS-MS subframe 301 and a BS-MS subframe 303. The RS-MS subframe 301 and the BS-MS subframe 303 are separately located in the single section (the first section) of the subframe 300 by a subframe-in-subframe scheme and have different bursts. Since the BS and a plurality of RSs perform transmission using the subframes (the RS-MS subframe 301 and the BS-MS subframe 303) of the first section, a permutation including a dedicated pilot can be used for each of the bursts.

The second section of the subframe 300 includes a BS-RS subframe 305 for communication between the BS and the RS. The BS-RS subframe 305 is separated from a link connected to the MS by a time resource. In this case, technologies such as smart antenna, Multi Input Multi Output (MIMO), and Vertical Bell Labs Layered Space-Time (VBLAST) technologies, can be easily used to provide a better environment to a BS-RS link.

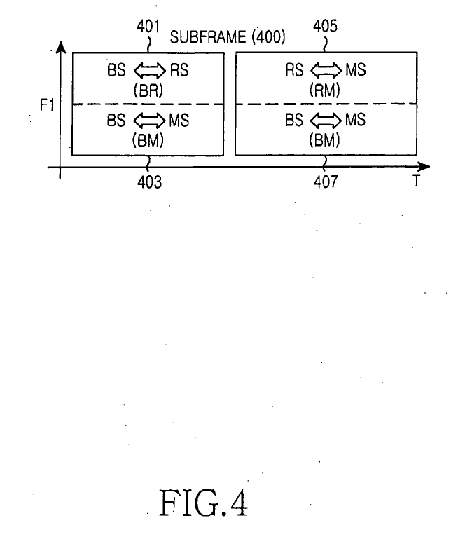

FIG. 4 illustrates a subframe structure for a multi-hop relay cellular network according to a third embodiment of the present invention.

Referring to FIG. 4, a subframe 400 includes a first section and a second section. The first section includes a BS-RS subframe 401 and a BS-MS subframe 403, and the second section includes an RS-MS subframe 405 and a BS-MS subframe 407. The BS-RS subframe 401 and the RS-MS subframe 405 are arranged by a subframe-by-subframe scheme, and the BS-MS subframes 403 and 407 are respectively arranged in the first and second sections by a frame-by-frame scheme. The first and second sections are separated using a time resource and can be arranged in a reversed order.

The first section for direct communication with the BS is divided into the BS-RS subframe 401 and the BS-MS subframe 403. The BS-RS subframe 401 and the BS-MS subframe 403 are separately located in the single section (the first section) of the subframe 400 by a subframe-in-subframe scheme and have different bursts. In the first section made up of the BS-RS subframe 401 and the BS-MS subframe 403, the BS transmits the same subframe. Therefore, the BS can broadcast control information commonly in the subframes 401 and 403.

Meanwhile, the RS-MS subframe 405 and the RS-MS subframe 407 are separately located in the single section (the second section) of the subframe 400 by a subframe-in-subframe scheme and have different bursts. As explained above, a permutation including a dedicated pilot is used for each of the bursts to avoid superposition of pilot subcarriers of the bursts. Further, the BS-MS subframes (links) 403 and 407 are assigned to bursts on a time priority basis so as to obtain narrowband operation gain as described above.

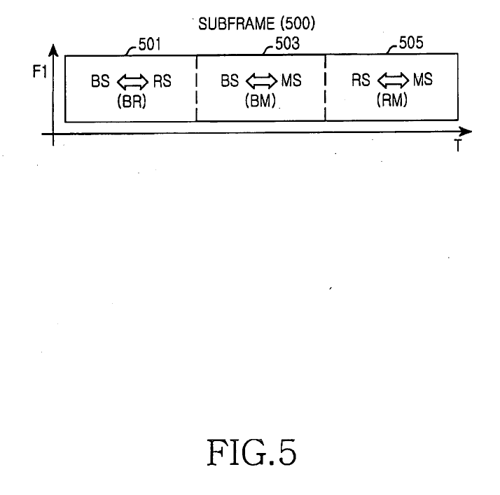

FIG. 5 illustrates a subframe structure for a multi-hop relay cellular network according to a fourth embodiment of the present invention.

Referring to FIG. 5, a subframe 500 includes a first section for a BS-RS subframe 501, a second section for a BS-MS subframe 503, and a third section for an RS-MS subframe 505. The first to third sections are constructed by a subframe-by-subframe scheme.

Since the BS-RS subframe 501 in the first section has an independent time slot, advanced technologies can be easily used and thus a better BS-RS link can be established. In the BS-MS subframe 503, burst allocation can be carried out using a common pilot, and in the RS-MS subframe 505, burst allocation is carried out using a dedicated pilot. Therefore, different type bursts can be transmitted through links by separating the BS-MS subframe 503 and the RS-MS subframe 505 using different time slots.

Furthermore, since the BS-MS subframe 503 is located between the BS-RS subframe 501 and the RS-MS subframe 505, an additional switching gap is not required for an RS in the subframe sections.

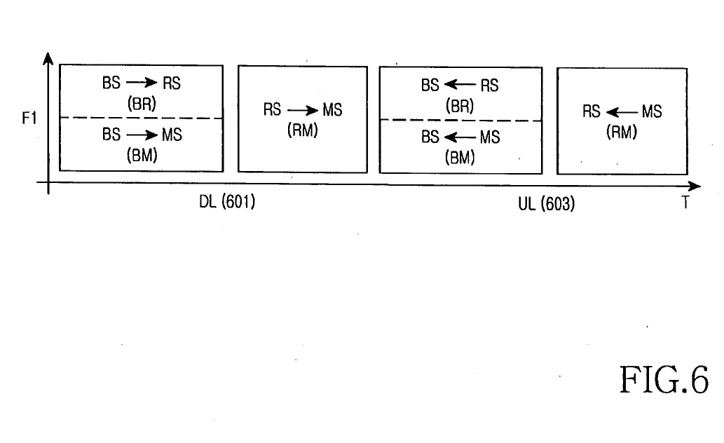

FIG. 6 illustrates a frame structure for a multi-hop relay cellular network according to a first embodiment of the present invention.

Referring to FIG. 6, a frame of the current embodiment includes a Downlink (DL) subframe 601 and an Uplink (UL) subframe 603 that are configured in the same manner as the subframe illustrated in FIG. 2.

The DL subframe 601 includes a first section divided into a BS-RS subframe and a BS-MS subframe, a second section made of an RS-MS subframe. Since a BS regards an RS as an MS, the BS does not repeatedly send control information to both the RS and MS. Further, in the UL subframe 603, subframes are transmitted using different time slots depending on receiving ends, so that interference due to non-synchronization can be prevented at a receiving end of the BS. Therefore, in the first section (the BS-RS subframe and the BS-MS subframe), bursts are allocated in a common pilot mode, and in the second section (the RS-MS subframe), bursts are allocated in a dedicated pilot mode.

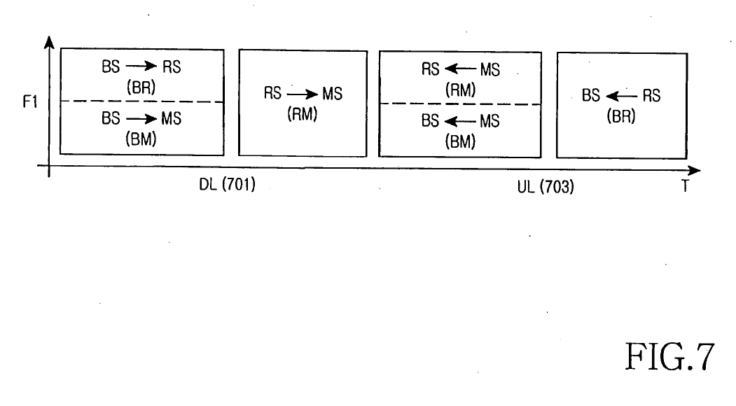

FIG. 7 illustrates a frame structure for a multi-hop relay cellular network according to a second embodiment of the present invention.

Referring to FIG. 7, a frame of the current embodiment includes a DL subframe 701 configured in the same manner as the subframe illustrated in FIG. 2 and an UL subframe 703 configured in the same manner as the subframe illustrated in FIG. 3.

The DL subframe 701 includes a first section divided into a BS-RS subframe and a BS-MS subframe, and a second section made up of an RS-MS subframe. Since a BS regards an RS as an MS, the BS does not repeatedly send control information to both the RS and MS. Therefore, in the first section (the BS-RS subframe and the BS-MS subframe), bursts are allocated in a common pilot mode, and in the second section (the RS-MS subframe), bursts are allocated in a dedicated pilot mode.

In the UL subframe 703, a BS-RS subframe is separated from a link for communication with the MS (i.e., an RS-MS subframe and a BS-MS subframe) by a time guard. Therefore, as explained above, advanced technologies can be easily used to improve an UL environment for the BS-RS subframe.

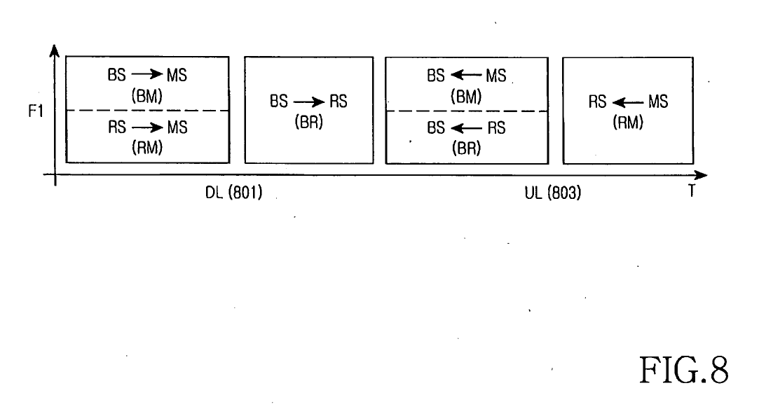

FIG. 8 illustrates a frame structure for a multi-hop relay cellular network according to a third embodiment of the present invention.

Referring to FIG. 8, a frame of the current embodiment includes a DL subframe 801 configured in the same manner as the subframe illustrated in FIG. 3 and an UL subframe 803 configured in the same manner as the subframe illustrated in FIG. 2.

In the DL subframe 801, a BS-MS subframe is separated from a link for an MS (i.e., an RS-MS subframe and a BS-MS subframe) by a time guard. Therefore, as explained above, advanced technologies can be easily used to improve a DL environment for the BS-RS subframe.

Further, in the UL subframe 803, subframes are transmitted using different time slots depending on receiving ends, so that interference due to non-synchronization can be prevented at a receiving end of the BS.

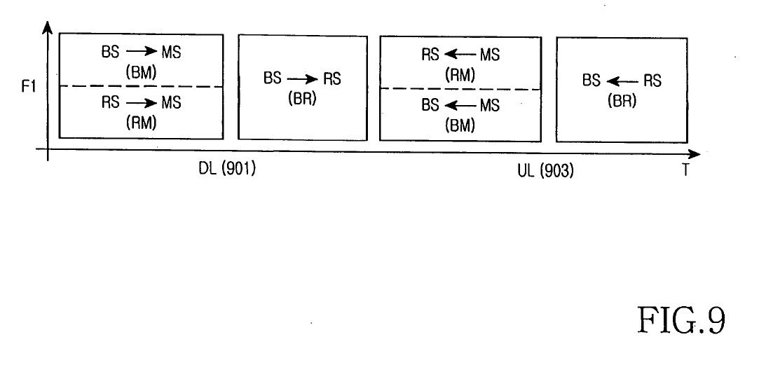

FIG. 9 illustrates a frame structure for a multi-hop relay cellular network according to a fourth embodiment of the present invention.

Referring to FIG. 9, a frame of the current embodiment includes a DL subframe 901 and an UL subframe 903 that are configured in the same manner as illustrated in FIG. 3.

Since BS-RS subframes of the DL subframe 901 and the UL subframe 903 are separated from links for an MS (i.e., RS-MS subframes and BS-MS subframes) by time guards, advanced technologies, such as smart antenna, MIMO, and VBLAST technologies, can be easily used to provide an improve link environment for the BS-RS subframes.

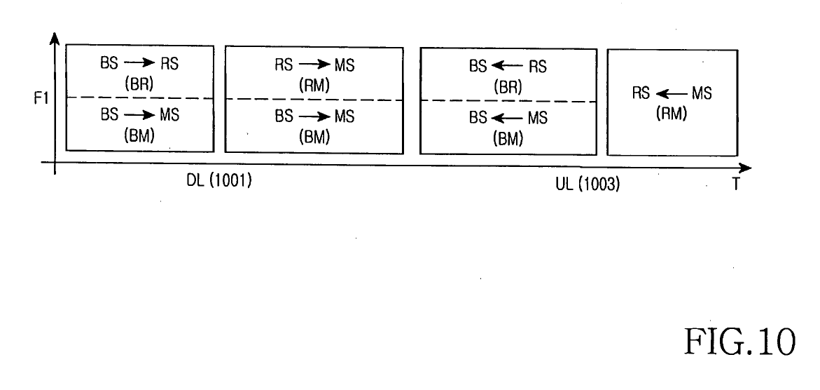

FIG. 10 illustrates a frame structure for a multi-hop relay cellular network according to a fifth embodiment of the present invention.

Referring to FIG. 10, a frame of the current embodiment includes a DL frame 1001 configured in the same manner as illustrated in FIG. 4 and an UL subframe 1003 configured in the same manner as illustrated in FIG. 2.

BS-MS subframes (links) of the DL subframe 1001 can be allocated to bursts in a time priority basis so as to obtain narrowband operation gain. Further, in BS-RS and BS-MS subframes of the DL subframe 1001, bursts are allocated in a common pilot mode, and in RS-MS and BS-MS subframes of the DL subframe 1001, bursts are allocated in a dedicated pilot mode.

Since a plurality of RSs or MSs transmit using the UL subframe 1003, bursts of subframes are allocated in a dedicated pilot mode. Further, subframes are transmitted using different time slots depending on receiving ends. Therefore, interference due to non-synchronization can be prevented at a receiving end of the BS.

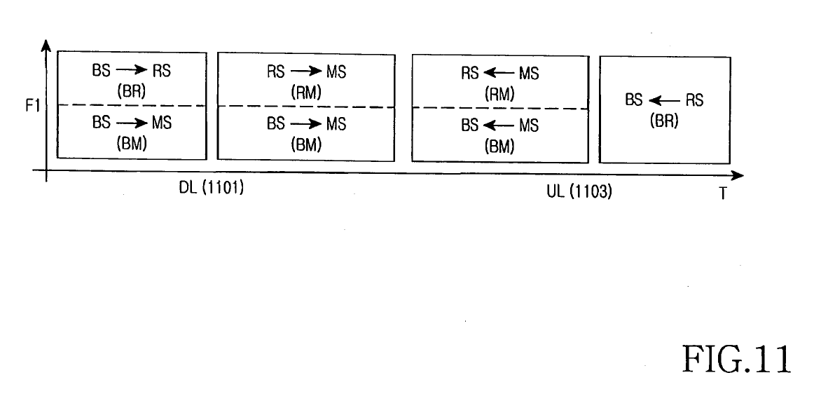

FIG. 11 illustrates a frame structure for a multi-hop relay cellular network according to a sixth embodiment of the present invention.

Referring to FIG. 11, a frame of the current embodiment includes a DL subframe 1101 configured in the same manner as illustrated in FIG. 4 and a UL subframe 1103 configured in the same manner as illustrated in FIG. 3.

BS-MS subframes of the DL subframe 1101 are allocated to bursts on a time priority basis so as to obtain narrow band gain. Further, BS-RS and BS-MS subframes of the DL subframe 1101 are allocated to bursts on a common pilot mode basis, and RS-MS and BS-MS subframes of the DL subframe 1101 are allocated to bursts on a dedicated pilot mode basis.

Since a plurality of RSs or MSs transmit using the UL subframe 1103, bursts are allocated in a dedicated pilot mode. Further, since an BS-RS subframe of the UL subframe 1103 is separated from links for an MS (i.e., an RS-MS subframe and a BS-MS subframe) by a time guard, advanced technologies, such as smart antenna, MIMO, and VBLAST technologies, can be easily used to provide an improve link environment for the BS-RS subframe.

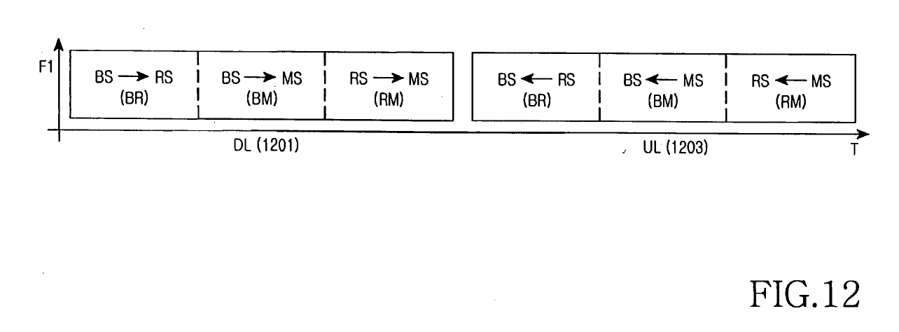

FIG. 12 illustrates a frame structure for a multi-hop relay cellular network according to a seventh embodiment of the present invention; and

Referring to FIG. 12, a frame of the current embodiment includes a DL subframe 1201 and an UL subframe 1203 that are configured in the same manner as illustrated in FIG. 5.

In each of the DL subframe 1201 and UL subframe 1203, a BS-RS subframe, a BS-MS subframe, and an RS-MS subframe are sequentially arranged. Since the BS-MS subframe is located between the BS-RS subframe and the RS-MS subframe, an additional gap is not required for an RS switching operation.

In addition to the embodiments illustrated in FIGS. 6 through 12, more frames can be provided by combining the subframe constructing schemes illustrated in FIGS. 2 through 5. Further, in each of the frames constructed using the subframe constructing schemes, information about section allocation can be transmitted using a frame control section of the frame. In this case, all RSs or MSs can recognize the structure of the frame from the received section allocation information.

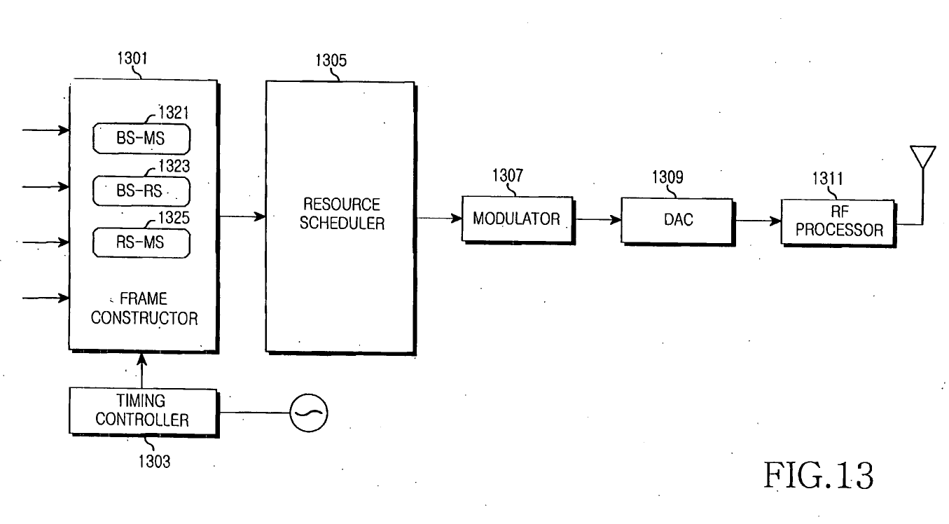

FIG. 13 illustrates an apparatus for constructing a frame in a multi-hop relay cellular network according to the present invention.

Referring to FIG. 13, a frame constructing apparatus of the present invention includes a frame constructor 1301, a timing controller 1303, a resource scheduler 1305, a modulator 1307, a Digital/Analog Converter (DAC) 1309, and a Radio Frequency (RF) processor 1311.

The frame constructor 1301 generates subframes for data received from an upper node according to the destinations of the data. For example, when the frame constructing apparatus is included in a BS, the frame constructor 1301 generates a BS-MS subframe 1321 using data destined for an MS directly connected to the BS, and a BS-RS subframe 1323 using data destined for an RS. When the frame constructing apparatus is included in an RS, the frame constructor 1301 generates an RS-MS subframe 1325 using data destined for an MS connected to the RS, and a BS-RS subframe 1323 using data destined for a BS. When the frame constructing apparatus is included in an MS, the frame constructor 1301 generates a BS-MS subframe 1321 in the case where the MS is directly connected to a BS and an RS-MS subframe 1325 in the case where the MS is connected to an RS by a relay link.

Further, the frame constructor 1301 receives a timing signal from the timing controller 1303 to construct a DL subframe or a UL subframe. For example, when the frame constructing apparatus is included in a BS, the frame constructor 1301 constructs a BS DL subframe using the BS-MS subframe 1321 and the BS-RS subframe 1323 according to the timing signal from the timing controller 1303.

The resource scheduler 1305 receives the subframe from the frame constructor 1301 and outputs the subframe according to the allocation of bursts of the subframe to a link.

The modulator 1307 receives the subframe from the resource scheduler 1305 and modulates the subframe into a predetermined modulation format. Then, the DAC 1309 converts the modulated subframe into an analog signal.

The RF processor 1311 receives the analog signal from the DAC 1309 and converts the analog signal into an RF signal. Then, the RF signal is transmitted through an antenna.

In the frame structure, the subframes can be separated from each other in the same frame section (time slots) by a frame-in-frame scheme. Alternatively, the subframes can be arranged over one or more frame sections (one or more sets of time slots) in the form of a superframe by a frame-by-frame scheme. For example, in the frame constructing apparatus depicted in FIG. 12, three time periods (first to third time periods) are included in one frame. In this case, the first time period may be occupied by one or more frame sections for transmission of BS-RS subframes, the second time period may be occupied by one or more frame sections for transmission of BS-MS subframes, and the third time period may be occupied by one or more frame sections for transmission of RS-MS subframes. In this way, subframes for a multi link can be arranged over a plurality of frames to make up a superframe. The frames illustrated in FIGS. 6 through 11 as well as the frame illustrated in FIG. 12 can be used to make up a superframe in the same or similar manner as described above. Furthermore, the subframes illustrated in FIGS. 2 through 5 can be used to make up a superframe by a frame-by-frame scheme as well as a frame-in-frame scheme.

As described above, according to the present invention, a frame can be generated which can support a multi link without interference in a multi-hop relay cellular network. Therefore, various advantages can be provided, such as avoiding interference between subframes, efficient use of resources, flexibility in using a pilot, easy utilization of advanced technologies, and reduction in switching gap overheads for an RS.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for constructing a subframe to support a multi link in a network, the method comprising the steps of:
constructing a first section of the subframe, the first section including a BS (Base station)-MS (Mobile Station) subframe for a link between a BS and an MS and an RS (Relay Station)-MS subframe for a link between an RS and the MS; and
constructing a second section of the subframe, the second section including a BS-RS subframe for a link between the BS and the RS.

2. The method of claim 1, wherein the first and second sections of the subframe are separated using a time resource.

3. The method of claim 1, wherein the BS-MS subframe and the RS-MS subframe of the first section are separated by an orthogonal resource and comprise different bursts.

4. The method of claim 3, wherein the orthogonal resource is one of time, frequency, space, and codes.

5. The method of claim 1, wherein the first section of the subframe comprises a dedicated pilot per burst, and the second section of the subframe comprises a common pilot.

6. A method for constructing a superframe to support a multi link in a multi-hop relay cellular network, the method comprising the steps of:
constructing a first frame including a BS-MS subframe for a link between a BS and an MS and an RS-MS subframe for a link between an RS and the MS; and
constructing a second frame including a BS-RS subframe for a link between the BS and the RS

7. A method for constructing a subframe to support a multi link in a multi-hop relay cellular network, the method comprising the steps of:
constructing a first section of the subframe, the first section including a BS-RS subframe for a link between a BS and an RS and an BS-MS subframe for a link between the BS and an MS; and
constructing a second section of the subframe, the second section including an RS-MS subframe for a link between the RS and the MS and a BS-MS subframe for a link between the BS and the MS.

8. The method of claim 7, wherein the BS-RS subframe and the BS-MS subframe of the first section are separated by an orthogonal resource and comprise different bursts.

9. The method of claim 8, wherein the orthogonal resource is one of time, frequency, space, and codes.

10. The method of claim 7, wherein the first section of the subframe comprises a common pilot, and the second section of the subframe comprises a dedicated pilot per burst.

11. The method of claim 7, wherein the RS-MS subframe and the BS-MS subframe of the second section are separated by an orthogonal resource and comprise different bursts.

12. The method of claim 11, wherein the orthogonal resource is one of time, frequency, space, and codes.

13. The method of claim 7, wherein the BS-MS subframes of the first and second sections comprise bursts on a time priority basis.

14. A method for constructing a superframe to support a multi link in a network, the method comprising the steps of:
constructing a first frame including a BS-RS subframe for a link between a BS and an RS and an BS-MS subframe for a link between the BS and an MS; and
constructing a second frame including an RS-MS subframe for a link between the RS and the MS and a BS-MS subframe for a link between the BS and the MS.

15. A method for constructing a subframe to support a multi link in a network, the method comprising the steps of:
constructing a BS-RS subframe for a link between a BS and an RS in a first section of the subframe;
constructing a BS-MS subframe for a link between the BS and an MS in a second section of the subframe; and
constructing an RS-MS subframe for a link between the RS and the MS in a third section of the subframe.

16. The method of claim 15, wherein the first and second sections comprise a common pilot, and the third section comprises a dedicated pilot per burst.

17. The method of claim 15, wherein the first to third sections are separated by a time resource.

18. A method for constructing a superframe to support a multi link in a multi-hop relay cellular network, the method comprising the steps of:
constructing a BS-RS subframe for a link between a BS and an RS in a first frame;
constructing a BS-MS subframe for a link between the BS and an MS in a second frame; and
constructing an RS-MS subframe for a link between the RS and the MS in a third frame.

19. A method for constructing a subframe to support a multi link in a network, the method comprising the steps of:
constructing a subframe for a direct link in a first section of the subframe; and
constructing a subframe for a relay link in a second section of the subframe.

20. The method of claim 19, wherein the first section comprises a common pilot, and the second section comprises a dedicated pilot per burst.

21. The method of claim 19, wherein the step of constructing the subframe for the direct link in the first section comprises constructing a BS-RS subframe for a link between a BS and an RS and a BS-MS subframe for a link between the BS and an MS.

22. The method of claim 21, wherein the BS-RS subframe and the BS-MS subframe of the first section are separated by an orthogonal resource and comprise different bursts.

23. The method of claim 22, wherein the orthogonal resource is one of time, frequency, space, and codes.

24. The method of claim 19, wherein the step of constructing the subframe for the relay link in the second section comprises constructing an RS-MS subframe for a link between an RS and an MS.

25. A method for constructing a superframe to support a multi link in a multi-hop relay cellular network, the method comprising the steps of:
constructing a subframe for a direct link in a first frame; and
constructing a subframe for a relay link in a second frame.

26. The method of claim 25, wherein the step of constructing the subframe for the direct link in the i^{th} frame comprises constructing a BS-RS subframe for a link between a BS and an RS and a BS-MS subframe for a link between the BS and an MS, and
the step of constructing the subframe for the relay link in the (i+1)^{th} frame comprises constructing an RS-MS subframe for a link between the RS and the MS.

27. An apparatus for constructing a frame to support a multi link in a network, the apparatus comprising:
a timing controller for generating a timing signal to provide information about a subframe transmission time according to a predetermined framing scheme;
a frame constructor for constructing a frame with subframes using the timing signal; and
a resource scheduler for mapping the subframes using resources allocated to bursts of each link.

28. The apparatus of claim 27, wherein the subframes comprise:
a BS-MS subframe for a link between a BS and an MS;
an RS-MS subframe for a link between an RS and the MS; and
a BS-RS subframe for a link between the BS and the RS.

29. The apparatus of claim 27, wherein the frame constructor maps bursts of a BS-MS subframe for a link between a BS and an MS and bursts of a BS-RS subframe for a link between the BS and an RS into a first section of the frame according to the timing signal using a two-dimensional scheme, and
the frame constructor maps bursts of an RS-MS subframe for a link between the RS and the MS into a second section of the frame according to the timing signal.

30. The apparatus of claim 27, wherein the frame constructor maps bursts of an RS-MS subframe for a link between an RS and an MS and bursts of a BS-MS subframe for a link between a BS and the RS into a first section of the frame according to the timing signal using a two-dimensional scheme, and
the frame constructor maps bursts of a BS-RS subframe for a link between the BS and the RS into a second section of the frame according to the timing signal.

31. The apparatus of claim 27, wherein the frame constructor maps bursts of an BS-RS subframe for a link between a BS and an RS and bursts of a BS-MS subframe for a link between the BS and an MS into a first section of the frame according to the timing signal using a two-dimensional scheme, and
the frame constructor maps bursts of an RS-MS subframe for a link between the RS and the MS and bursts of a BS-MS subframe for a link between the BS and the MS into a second section of the frame according to the timing signal using the two-dimensional scheme.

32. The apparatus of claim 31, wherein the bursts of the BS-MS ubframes of the first and second sections are mapped on a time priority basis.

33. The apparatus of claim 27, wherein the frame constructor maps bursts of a BS-RS subframe for a link between a BS and an RS into a first section of the frame, bursts of a BS-MS subframe for a link between the BS and an MS into a second section of the frame, and bursts of an RS-MS subframe for a link between the RS and the MS into a third section of the frame, according to the timing signal.
